(19) United States
(12) Patent Application Publication
(10) Pub. No.: US 2023/0334608 A1
(43) Pub. Date: Oct. 19, 2023

(54) INTEGRATED METHODS AND TECHNOLOGIES TO TRACK AND CERTIFY THE SKILLS AND SMART WORKING OF THE WORKERS AND MULTIPLY WELFARE SERVICES WITH A LOGIC OF SHARING ECONOMY

(71) Applicants: Luca SANSONE, Castellammare di Stabia (IT); MEDITERRANEO LAB 4.0 S.R.L., Sant'Egidio del Monte Albino (IT)

(72) Inventors: Luca SANSONE, Castellammare di Stabia (IT); Giampiero ZITO, Nocera Inferiore (IT)

(21) Appl. No.: 17/995,192

(22) PCT Filed: Mar. 3, 2021
(86) PCT No.: PCT/IT2021/050048

§ 371 Date: Sep. 30, 2022

(30) Foreign Application Priority Data
Apr. 8, 2020 (IT) 102020000007453

(51) Int. Cl. G06Q 50/20; H04L 9/40

(52) U.S. Cl. CPC G06Q 50/2057; H04L 63/08

(57) ABSTRACT

This patent application for invention refers in general to distance learning, flexible corporate welfare benefits and smart working i.e. concerns the implementation of an e-learning/e-welfare/e-working process through a single web platform, integrated with blockchain technology and artificial intelligence, able to guide the end user in the operation in accordance with the profile with which it has been identified, traced and certified.

### FIELD OF TECHNOLOGY

This patent application for invention refers in general to distance learning, flexible corporate welfare benefits and smart working. In the present case, the invention is a realization of an infrastructure equipped with all the functionalities for an integrated and efficient management of the processes tied to the fruition and delivery of the training services, of remote “Welfare”, as well as working remotely in certified agile mode. Moreover, there is the possibility to buy also local services of partners like the micro and small companies (social innovation). The exchange (use of corporate credits and purchases) between users, customers and partners (public and private companies, workers and third party sellers) produces a value that will be redistributed (revenue sharing) in quota part and again introduced in the circuit in order to increase more and more the plafond of the welfare services and to re-establish the balance life of the workers.

### Known Art

The e-learning sector is increasingly used in synergy also with the concept of smart-working reinforced nowadays by situations such as those for epidemiological causes, bringing both significant reductions in environmental impact and greater balances between work and life. These technical advantages, which are already well known, are identifiable and intuitive, since people are prevented from moving from a place of departure to a place of learning, in addition to the temporal aspect, since the necessary time of transport is reduced and the time devoted to other aspects of life is extended, such as staying at home. However, this approach raises issues regarding user authentication and traceability and demonstrability of the activities mentioned above. In fact, the authentication of users who interact electronically with the channels of regulated dissemination of information and knowledge, which as regards training and also other aspects of social welfare, has the aim of obtaining a qualification to be asserted in the professional and working environment at different levels. The problem that often arises and that can sometimes invalidate the use of “remote” modes, is the authentication of the user who is about to activate an on-line session to access contents and services remotely and the consequent traceability and certification of the entire flow and outputs obtained.

Another consideration is that at the moment there is a platform that gives not only aspects of distance learning but also services of “welfare and distance work” whether of a corporate or state type or services that user X can use without necessarily moving physically, as well as being aware of useful credits of any nature issued by its client and/or service provider.

There is also no platform that uses integrated blockchain and AI technologies designed in the e-welfare/e-learning/e-working mode.

Therefore, there is no technical solution to this issue in known art at the moment. In such sense there are patent applications that deal the question of the welfare with technology blockchain type “CN110443580A Public welfare management method and system based on block chain” although in a very inappropriate way or is applied exclusively to the public sector or donations to public bodies.

A further example is the patent “JP2003006307A WELFARE NETWORK SYSTEM”, which as can be seen from the title itself, implements a method that creates a network of systems that interact in order to offer more social welfare services but does not give guarantees of authentication and other services related to distance learning in synergy with the company Welfare.

Other industrial rights entitled “T02011A000163 System for the assessment of competences, for example for distance learning” has an interesting system of distance learning but it does not in any way address the technical advantage of including such methods combined with social services provided by the company, nor does it use blockchain technology for the traceability of skills and the processing of the relevant certified curriculum vitae.

Moreover, the technologies that support remote work are already widespread, as are the platforms that offer all the tools to support smart working (among the main Cisco webex meetings, G-Suite, Microsoft teams etc.).

### DESCRIPTION OF THE INVENTION

The aim of this invention is to ensure an efficient and effective method, a complete “all-in-one” tool to activate, in a distinct or integrated way, remote work solutions, training and/or welfare provided by national and international suppliers, diversified and customizable according to specific needs, company size and investment possibilities.

This invention concerns the implementation of an e-learning/e-welfare/e-working process through a single web platform, integrated with blockchain technology and artificial intelligence, able to guide the end user in the operation in accordance with the profile with which it has been identified, traced and certified.

Correct and secure identification in blockchain of the user according to compliant norms (kyc), allows the traceability and the demonstrability that the same has had access and used fully that type of formative offer, that flexible benefit or worked that day at that practice or project.

In the case of training, the user/worker will find a booklet of skills traced in blockchain that can be used both for career development purposes and against interested third parties (curriculum vitae also non-formal competences). In the case of smart working the user/worker will find tracked the workloads and related outputs (practical evaded, etc.), demonstrating its “productivity”.

Artificial Intelligence will speed up the processes of the platform to elaborate:
for the customer (company) a training offer (personalized catalogue) ad hoc on its production, innovation and development needs; for smart working the workload will be calculated by the systems and cross-checked with employment contracts and company directives;
for users (workers), the possibility of choosing benefits more useful to their personal and family needs.

The further purpose of this invention is to provide a number of features:
Access to the portal. Users who connect to the platform or directly to application resources, if enabled, are subjected to an authentication phase based on the use of a digital certificate. The authentication form acquires some information from the certificate and verifies its validity using the various databases available (Revocation List, Black/White List, etc.). Integration with authentication system to trace data and operations on blockchain or kyc (know your consumer) with personal data (doc identity, iban, etc.).
Self Registration. On first access, the system requires the user to perform a registration procedure, that is, the user will be required to specify, from a list of possible roles, those with which it is intended to access the services offered by the system. The user will have, at any time, the possibility to vary the set of roles selected (change the user profile). Downstream from the selection, the Role Verification step is activated, which through the Role Certifiers and Data Sources verifies the real ownership of the role by the user.
Verification of the Role. The veracity of the data provided by the user (the role) will be verified by the system asynchronously with respect to the registration or change of the user profile. Periodically the system will also independently verify the validity of associations between roles and users. The verification of the role and the functionalities related to it are realized through the role Manager that thanks to a series of adapters is able to interrogate the various Sources Data. You get a blockchain ID Management (certificate of adherence to the business organization).
Access to the resources. The user after the authentication phase, selecting a resource, among those available to him according to profiling, accesses the functionalities from this exposed. The contents, the operations will be contextualized depending on the platform profile and depending on whether the company has opted for flexible benefits and/or training services. The library with the training courses ad hoc for the type of job function and the consequent benefits for category of business contract will be calculated and presented to the user thanks to algorithms and machine learning (A.I.).
Management of resources. The user after the authentication phase, depending on the type of profile inside the platform will be able to manage, autonomously own resources. For example: an Association activates the service to the associated companies; a company identifies which benefits previewed from the Single text on Taxes on the Income (in the Italian case according to TUIR, art.51 and art.100) to place on disposition of its dependent; an employee chooses independently of which goods and services to use also seizing the opportunities of tax reduction; an agency proposes notices, notices and bonuses on the formation. Moreover, it is evidenced that the contents are of property of the platform and regarding the agencies that use of the platform they are only certifiers of formation according to regional laws. Further technical advantage is that the platform, downstream of the activities provided, will be able to provide: certification of courses and attendance to events (or FAD, acronym of distance training) traced with technology blockchain (event certified management); updating user profile, according to skills acquired with export possibilities (CV, Certificates, etc.).
Workbench. After the authentication phase, users are presented with an area dedicated to each user, “workbench”, with all the platform resources (services, documentation, courses) that they can access based on the roles owned/declared/certified. The workbench is generated in dual mode: automatic or match between user profiling and platform resources; manual or resources selected by the user, through search or external links. It should be noted that as regards sales&marketing area (that is offers ad hoc by external partners such as travel agencies, gyms, shops, etc.) every user will have to tick ad hoc privacy and promote communications of commercial offers that have nothing to do with flexible benefits and professional training services.
Functionality of the Administration. They allow the administrator to perform administrative tasks in the different areas such as Portal, Manager role etc. Common feature of the Administration are the use of a web interface, access through the platform, the definition of a particular Administrator role that allows access to the functions of Administration of the individual subsystems.

Another purpose of the present invention is the possibility to implement an architectural model that holds as a specialization of the paradigm to three levels, in which the engine of Business Intelligence constitutes the intermediate layer between the presentation Layer, of which the user interface is the emanation, and the Data Layer, which represents the data source entirely based on standard Internet protocols, including HTTP/HTTPS, XML and SOAP (Simple Object Access Protocol). Further features and advantages of the platform according to the invention will become clearer with the following detailed description of a form of realization of the found, made with reference to the attached drawings, provided purely for illustrative and not limiting.

### DETAILED DESCRIPTION OF THE INVENTION

In the present found emerges mainly the outline of the application architecture 100 comprising:
a model-based Service oriented Architecture (SOA), based entirely on open web standards and proven standard technology, which implements all logic to define and manage business objects and establish them, through the use of the role Manager, interaction with FAD and Welfare services. The technical advantage is to be able to implement a “model-based”—“model-driven” approach allowing the system to define in real time different business models so as to adapt to processes and rules of interaction between them in a dynamic and flexible way;
The blockchain Integration Logic component, connected to the blockchain, which manages its operation: keeps the connection to the network nodes active and, downstream of appropriate security controls, prepares the signed transactions to be sent on the blockchain;
Module for the management of the entire training process dedicated to companies and individual bodies called FAD services, allowing: —the organization of courses; —analysis of training needs (business needs); —convocation of participants; —attendance detection and certification; —issuing of training certificates and credits (in blockchain); —sources of funding (inter-professional funds/training bonuses 4.0); —budgeting;
Welfare Services. Service dedicated to the management of the company welfare dedicated to the management of flexible benefits, additional and/or alternative forms of remuneration that consist of goods and services completely tax free both for the company and for the worker. Allowing in synergy with the role Manager, to manage the benefits in a customizable way: —the company, identifies which benefits provided by the Law on Income Taxes (in the Italian context, TUIR, art.51 and art. 100) make available to its employees, on a voluntary basis or on the basis of the level of productivity calculated according to the modalities chosen by the company and traced by the blockchain systems;—the workers choose independently through the interface with the platform of which goods and services to use, in relation to the ceilings of expenditure defined by the company;
Role Manager. Verify that users are entitled to the roles they claim to have, by querying, through a series of adapters, the different data sources. It allows you to manage roles, criteria, resources and the association between them.

Another advantage of the present invention in reference to smart working is the blockchain integrated in the platform with the objective to certify and notarize the data of the produced outputs from the worker with a sure and immovable time mark. The executive in charge of the P.A. or the private company, in relation to the employment contracts and to the directives issued on the requirements of the employer, will evaluate if the assigned workload and the consequential level of productivity has been respected. In addition, blockchain intervenes with smart contracts to identify the responsibilities (obligations) of individual workers (such as project managers or stroke experts) in the project, without prejudice to notarisation (individual project tasks) as above in daily or monthly work (depending on directives).

Subsequently there are applications, always in blockchain, such as traceability systems to certify the workflow of each of them working in various ways at project parts, certifying, beyond the level of productivity, including any intellectual property. There is therefore a twofold technical advantage: —offering tools to track and certify the presence of work from home (interactive badge); —measuring (certifying) the productivity of smart-workers.

### DESCRIPTION OF THE FIGURES

FIG. 1 illustrates a first outline of the high-level 100 architecture for the method of operation of e-welfare and e-learning.

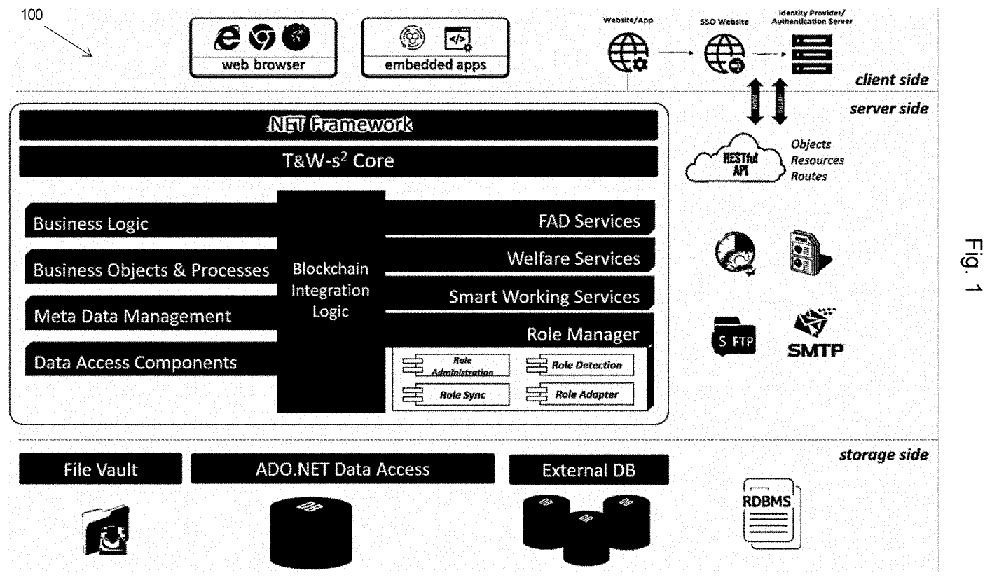

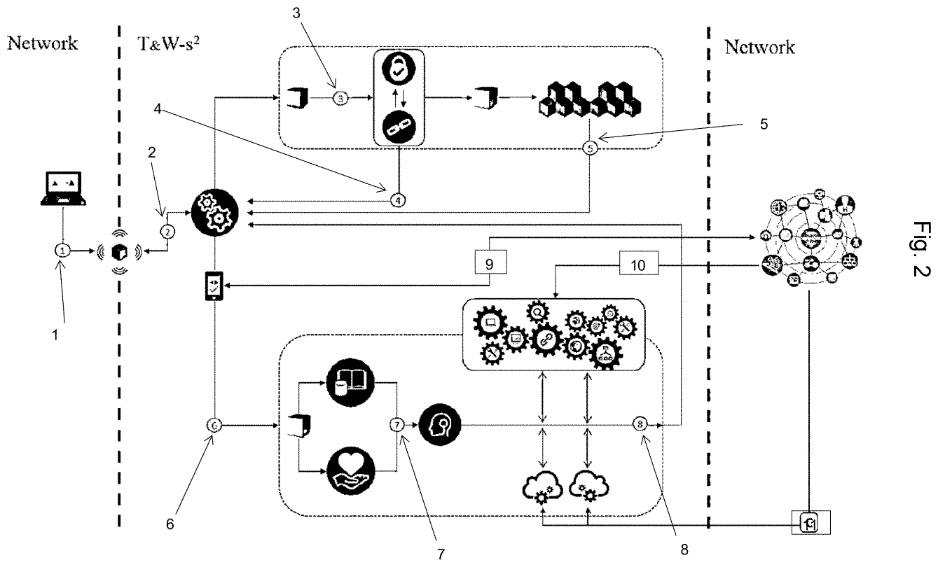

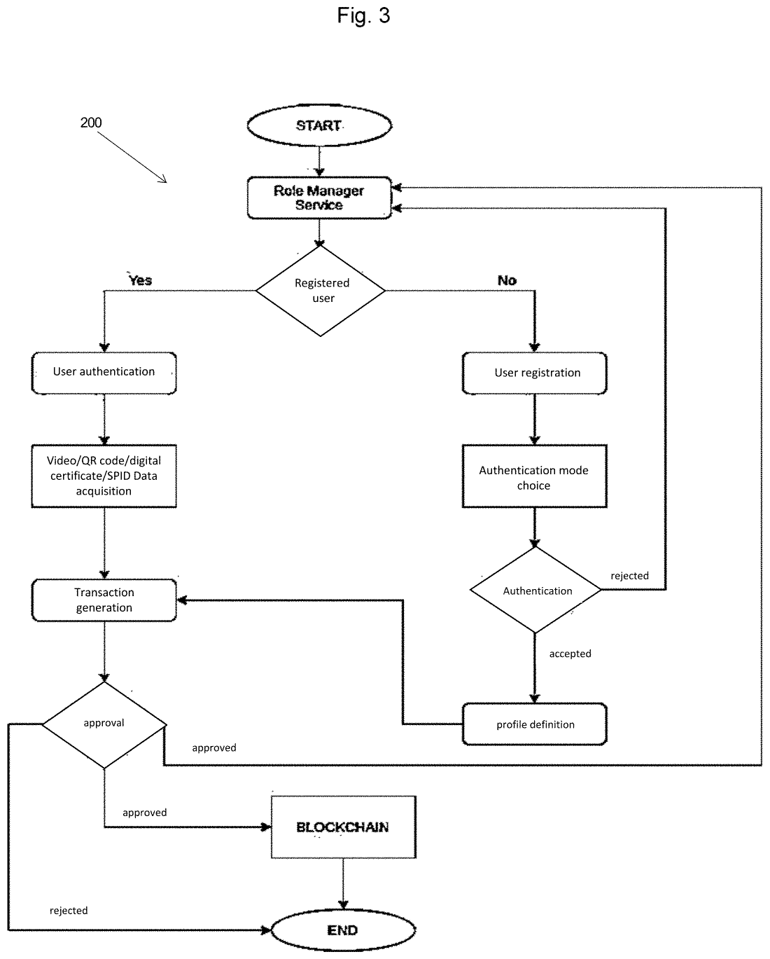

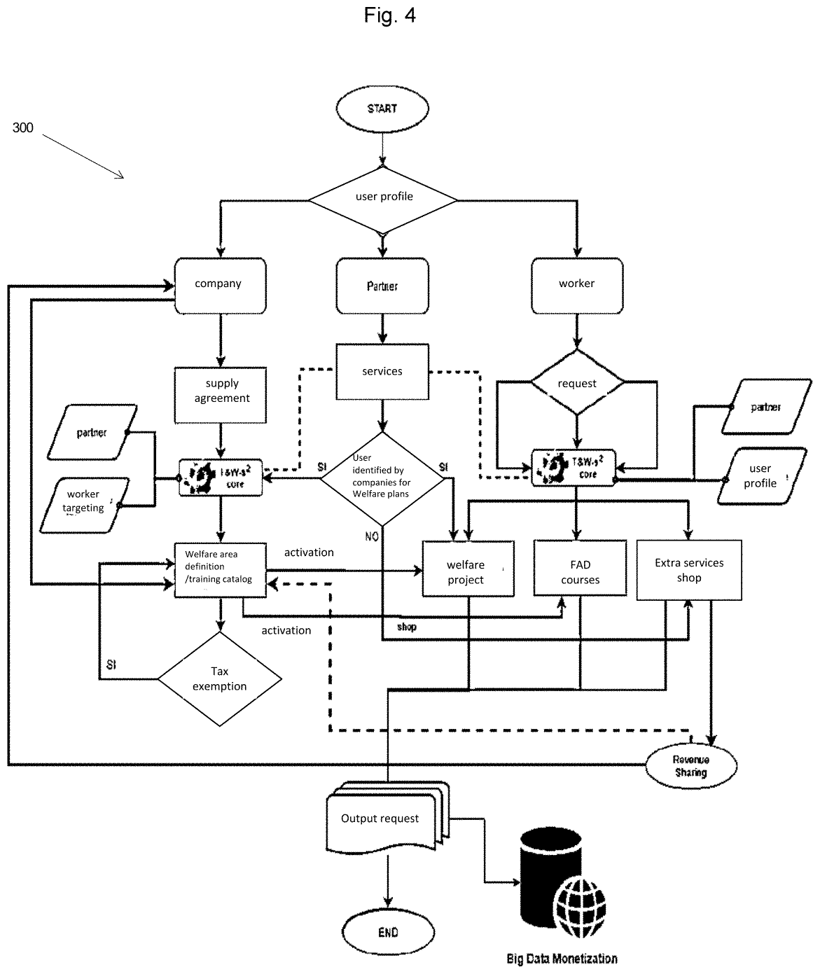

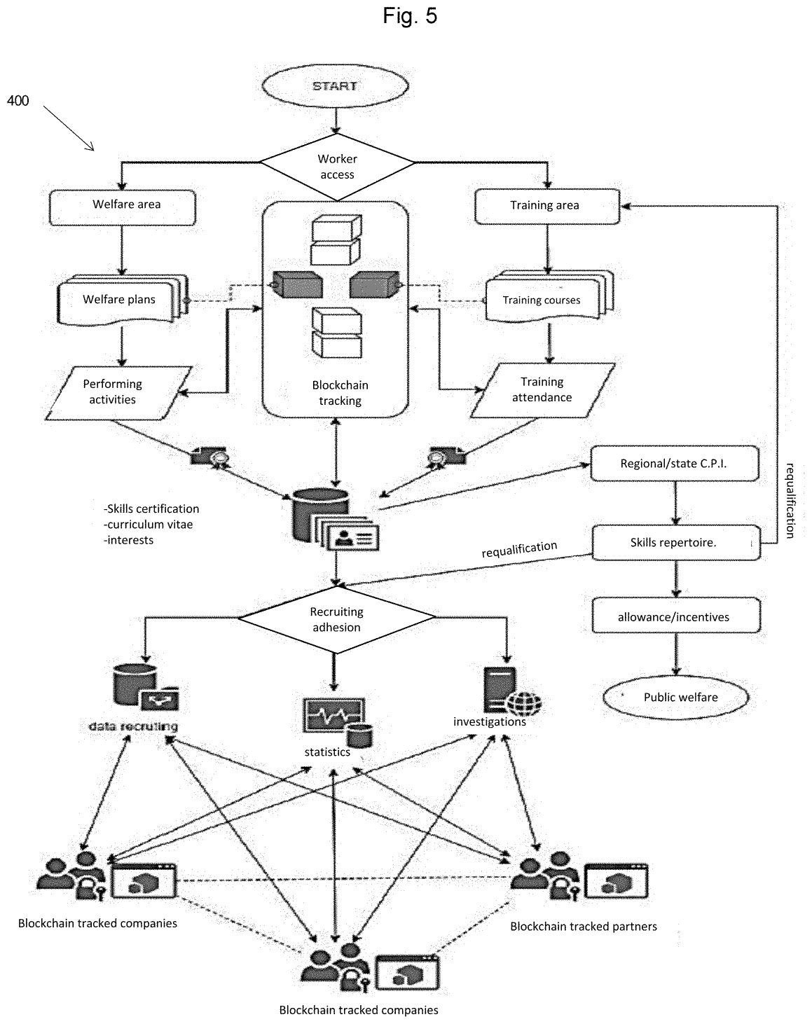

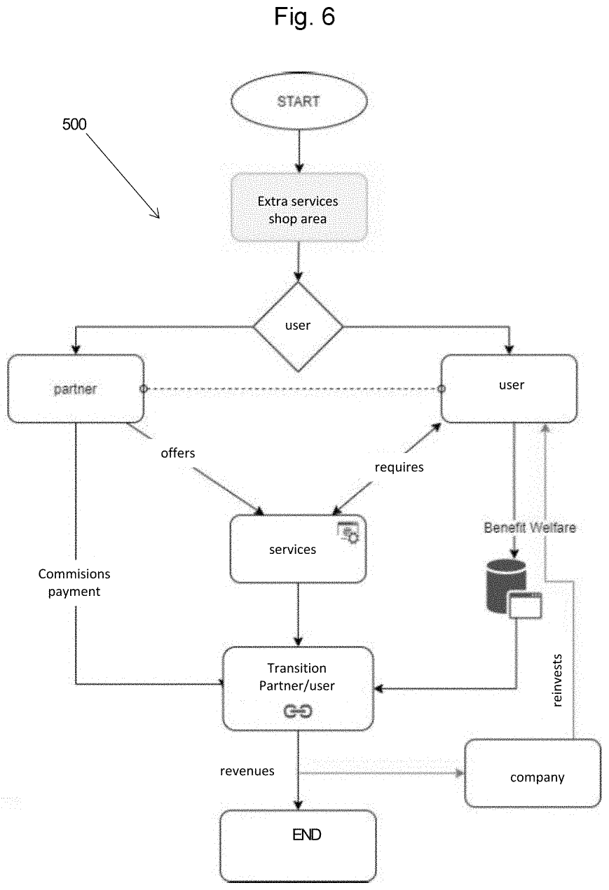

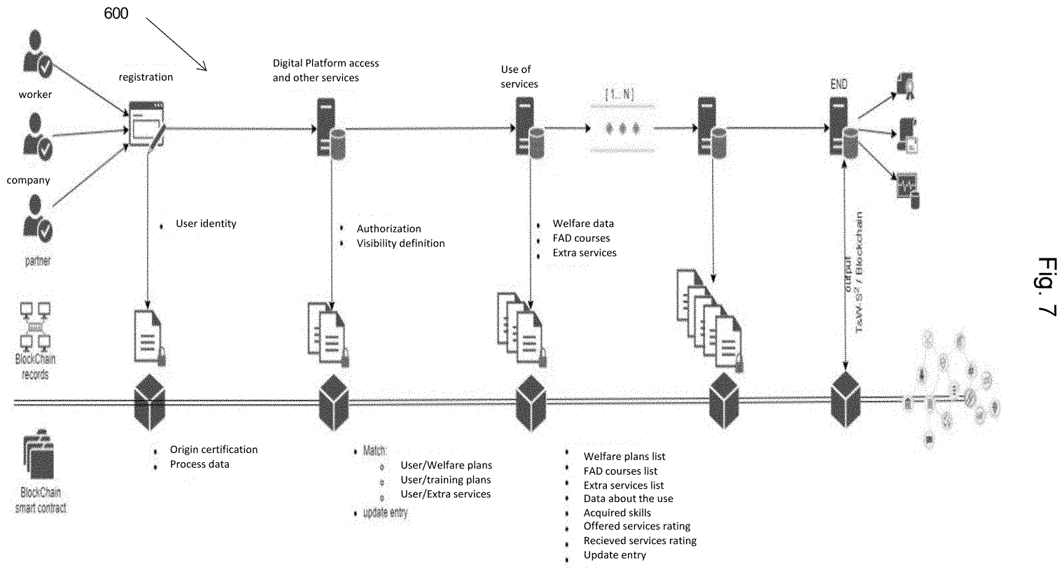

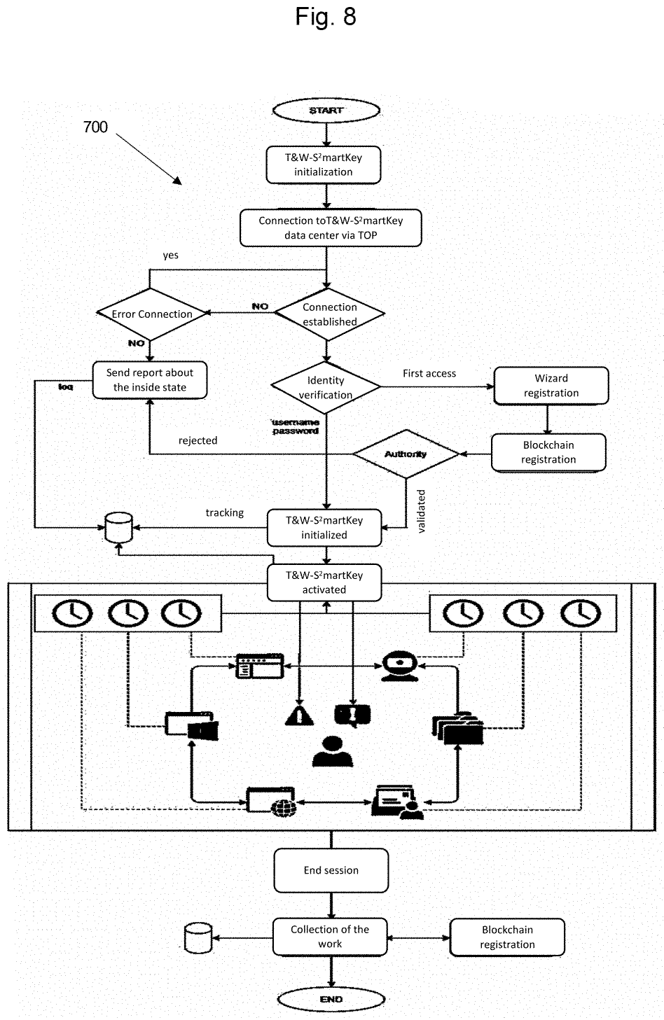

FIG. 2 shows a flow diagram characterized by:
1. A user (worker, company, etc.) accesses the application and makes a request (login/use of a service)
2. The route application identifies the type of request and it is the sorts it to the application form;
3. The request is processed by the authentication & authorization form which validates the applicant's content and status;
4. case of rejected request and
5. case of validated request where the combined transaction takes place together with others so as to create a new permanent and unalterable block inside the blockchain;
6. The user selects the area he wants to access: FAD and/or Welfare;
7. The type of information required and/or available within the platform shall be determined;
8. identified the requested resource, regardless of its possible use, the request is processed with the purpose of:
   Determine the actual operation of the user, with possibility of extraction of KPI (acronym of Key Performance indicator) for the final evaluation, in terms of workloads, processing times, levels of competence achieved. These KPIs will be, worker side, certification of the fulfilment of their duties, company side, the measure to determine the additional level of contribution intended for welfare.
   Train the network to recognize the type of user so as to always offer primary and related services in line with the needs of the user (detailed targeting):
For extra core services (Shop), make fast and efficient user connection-partner 9, because the user will be able to access services in line with their needs and partners will be able to provide ad hoc packages with the needs of users 10-11.
For core services, it facilitates the identification of welfare areas and training areas/levels in line with user profiles and needs.

Moreover 9 the authorized user will have access to the net of the services, extra platform, of the partner affiliates to the platform. Percentage of services offered 10 and used in the platform by partners, according to the Sharing revenue model, is part of the platform to be invested on budgets for welfare policies. Partner 11 offer extra or compliant services to donated services.

FIG. 3 illustrates 200 an authentication system using the security resulting from the application of blockchain Technology to ensure:
maximum security provided by the advanced encryption system;
simple interoperability between different areas;
maximum transparency and auditability of access and information;
   and reports the logical sequence of a/platform user interaction using blockchain technology, in particular the login phase:
User X has to log in the platform;
address the request to the role manager:
   If you are registered you provide your personal data for access
   If the user is not registered, he enrolls, providing all necessary data;
Received the data, a transaction is created consisting of a number of elements such as the recipient's public address, transaction information and cryptographic keys and other information necessary to complete the access framework (username, password, qr code, webcam image, etc.);
The transaction is generated with the user's Digital signature and Public Key;
A new Block with all transaction data is created. The block, which also includes other transactions, is prepared to be submitted for verification and approval by blockchain participants;
The new Block is added to the block chain that forms the blockchain and is accessible to all participants and is in the archive of all participants. It becomes the permanent, immutable and unchangeable reference of that specific transaction;
If the information is considered correct, the transaction is authorised, validated and carried out. At that point, the transaction becomes part of a New Block that is created and that also includes this transaction;
The user will be able to access the services offered by the platform, the role manager registers the event.

FIG. 4 shows 300 a flow diagram represented by three main blocks:
Company: —to sign the agreement for the supply of the platform, optionally identifying the partner that can accompany it in the introduction of the welfare plan; —configure its contents, understood as welfare areas for which it intends to make available credits for collaborators; —management tax exemption, for welfare areas that provide tax advantages, as indicated by the legislation introduced by the Budget Law 2017 and previous references; —Activates its welfare projects by providing the list of contributors and the amount in welfare credits available, with the possibility of setting special limits for homogeneous categories of employees;—Define your training catalog; —Activate FAD courses by providing a list of users' contributors;
Partners: —Define the offers the goods and solutions for the company Welfare, describing and customizing its packages dedicated to companies; —Publish your training packages and/or join the tutoring for existing FAD plans; —Publish its goods and solutions for extra-platform services;
Worker: —access to services and benefits prepared by your company for different areas of your life: health care, family and education, local public transport, shopping, culture and supplementary insurance; —access and participate in training courses provided by their own company and/or third parties;—Access to the extra services offered and provided by the partners (area shop, where the adherence to marketing plans of external partners for services other than core ones or welfare and training, part of the revenues can be put back in the platform or in the revenue sharing model towards the companies which, in turn, reinvest them on welfare policies;
The platform: —records every type of operation and data on blockchain, ensuring to all the actors the execution of reliable, verified and validated transactions, able to minimize the risks of compromise of the data; —learns, thanks to embedded algorithms of I.A., the interactions of the actors with the platform in order to facilitate:
   for the company: —the choice of the most reliable partners and with the services more adherent to the initiatives that they intend to publish in the platform, be they welfare plans and/or training; —the management of welfare plans, composing the types of benefits according to business needs and preferences, oriented to the well-being of employees.
   for partners:—the identification of companies according to the services offered; —the definition of extra services to be addressed to users according to the major requests.
   for workers: —the choice of the set of services and benefits to ensure a real and personal benefit in the different areas of life: health care, family and education; —local public transport, shopping, culture and supplementary welfare; —the identification of a training course in line with one's own needs/curricular experiences; —through express authorization, the visibility of one's own professional profile, detected and certified by the platform, in the affiliated job-recruting networks.

FIG. 5 illustrates 400 All data (big data) of users held by the platform, with the consent of the parties, they will be a heritage on which to guide new services such as the traceability of workers' skills and job profiles or skills booklet.

For example:
a worker participates in a FAD (technical competence) course that is traced in blockchain and certified on competence booklet; then through welfare services participates in social activities that may fall under non-formal competences (U.E.); you will find that these skills have been certified and will be able to agree to publish CVs in the recruitment database for the private sector.
a worker receives incentives from the state to supplement income; in this case he could provide deputies from the state or regions (section on the right in the figure) updated and certified competence book in blockchain and continue to use public welfare services based on merit logic and professional updating, according to state guidelines and in relation to the evolution of the labour market, even if you become unemployed later (retraining of unemployed workers).

FIG. 6 illustrates 500 the area “shop extra services” or employees manage their benefits choosing from many packages, proposed by the partners certified in blockchain, divided into different categories: sport, culture, wellness, health, shopping, family, health care, travel, etc. By accessing the “shop extra services” area, partners offer their services to a network of potential new blockchain certified customers. When the parties have identified the common good (Partner to sell —user to acquire) the transaction will be managed through in blockchain, that is it will be:
defined a smart contract containing the above conditions;
the smart contract will be inserted in the blockchain;
blockchain itself becomes the guarantor of the contract; When consent is obtained in the network, the contract “executes” the terms;
When the conditions have been executed, the blockchain will be updated by the system status change.

FIG. 7 illustrates 600 The tracking architecture of the T&W-s2 system allows to monitor and record every process step that will be documented by the records in blockchain, making the whole path certified. Tracing the events from the beginning generates a “Track Record History” of events that allow to certify all the processes and the events regarding the salient phases in the definition and the fruition of the plans and formative in a distributed register, decentralized and inviolable, guaranteeing the certification. Each stage of the process can be traced, allowing the main actors of the platform and third parties to verify its authenticity. In principle, it works as follows:
during registration creates a special KEY ID (As Record Writing ID) that will distinguish the user;
record every process or product (Track Record) through the Smart-contract by signing the records with the Private Key received during creation;
the processes related to the definition of welfare plans, training plans, benefits received, courses performed, workloads, extra-used services are added as indelible records, while certifying the authenticity of what the performer has declared.

The use of I.A. algorithms in the platform, in synergy with the writing in blockchain is presented as the system able to cross any type of data turns around the actors of the platform providing all the essential data for the logical reconstruction of the same and for the verification of the validity of a certificate and of its contents.

FIG. 8 illustrates 700 enhanced algorithms with systems of artificial intelligence that is for the greater and facilitated use of all these technologies (user experience) and the use of APPs for the objectives described above, the platform will be integrated within a device “key/token” for the traceability and usability of the smart working service:
The worker will be provided with the “Smart Key”, previously associated with the employee's registry. At the first access the worker following the instructions will validate his digital identity giving consent to trace it on the distributed registers of the blockchain. Only after this validation by the certifying authority, the user (worker) can certify his presence at work.
The association described above will enable the necessary algorithms to be activated to determine the activities that the worker will carry out, according to conceptual maps that will be defined during their use. The conceptual maps are to be understood as graphs that will expand or contract during use, starting from the template base Role-Tool, determined by the type of work contract, needs and business directives.
“Smart Key”, from the moment of its activation, performs the startup of its services of worker assistant: —Tracks the interaction of the user only with the tools of job (in the respect of the privacy) —Identifies and suggests pause; —Perform silent controls to assess the presence and workflow of the operator (depending on the loads assigned or the precise hours according to company guidelines).

The present invention has been described for illustration, but not limited, according to its preferred forms of realization, but it is understood that variations and/or modifications can be made by experts in the branch without for this reason going beyond its scope of protection, as defined in the attached claims.

1. Method for the traceability and certification of remote work, distance training (called FAD), and corporate welfare services on a web platform called the method (100), which uses:
a blockchain with Blockchain Integration Logic (BIL);
a model-based Service-Oriented Architecture (SOA), including a role Manager—said SOA that, through a series of adapters, manages roles, criteria, resources, and the association among them;
said web platform being suitable for the control of
an initial module for the management of the entire training process dedicated to companies and bodies that permit or are under obligation for remote work on a web platform;
a second module that manages distance training (FAD) at companies and individual bodies;
a third module that manages corporate welfare;
therefore, a BIL, a SOA, a RM and Adapters define a web platform that registers the operations carried out within it in the blockchain, by means of verified and validated transactions; said web platform learns from the users' interactions by means of Artificial Intelligence (AI) algorithms, and develops digital experiences customized for each user (1);
this method comprises the following steps:
the user's (1) access to the web platform;
the user (1) is registered and logs in by providing his or her personal data;
the application route (2) sorts the access request (3) to the web platform's authentication form;
the authentication form verifies the user's (1) data and processes the access request;
platform's authentication form;
the authorization form, through the RM, identifies the user (1) and accepts the access request (3);
the web platform initializes communication with the blockchain, which generates a permanent and unalterable block;
the user (1) selects (6) one from the first, second, and third modules;
the web platform's core determines the requested information (7) and defines whether it is present in the web platform;
the web platform's core identifies (8) the requested form and processes the request;
AI interaction with the generated block;
AI's continuous learning to recognize the user (1) and optimize his or her experience on the web platform;
use of the data processed by AI, by the other platform modules, the core, and the blockchain administrators;
the core registers the event;
user's (1) logout;
closing and archiving of the generated block.

2. Method according to claim 1, which comprises the following steps:
the user's (1) access to the web platform;
the user (1) is registered and logs in by providing his or her personal data;
the application route (2) sorts the access request (3) to the web platform's authentication form;
the authentication form verifies the user's (1) data and processes the access request;
the application route (2) sorts the access request (3) to the web platform's authentication form;
the authorization form, through the RM, identifies the user (1) and rejects the access request (4);
the user (1) reattempts access or forwards the request for access credentials to the blockchain administrators.

3. Method according to claim 1, which comprises the following steps:
the user's (1) access to the web platform;
the user (1) is not registered, and performs the registration;
the application route (2) sorts the access request (3) to the web platform's authentication form;
the authentication form verifies the user's (1) data and processes the access request;
the application route (2) sorts the access request (3) to the web platform's authentication form;
the authorization form, through the RM, identifies the user (1) and accepts the access request (3);
the web platform initializes communication with the blockchain, which generates a permanent and unalterable block;
the user (1) selects (6) one from the first, second, and third forms;
the web platform's core determines the requested information (7) and defines whether it is present in the web platform;
the web platform's core identifies (8) the requested form and processes the request
AI interaction with the generated block;
AI's continuous learning to recognize the user (1) and optimize his or her experience on the web platform;
use of the data processed by AI, by the other platform modules, the core, and the blockchain administrators;
the core registers the event;
user's (1) logout;
closing and archiving of the generated block.

4. Method according to claim 1, which comprises the following steps:
the user's (1) access to the web platform;
the user (1) is not registered, and performs the registration;
platform's authentication form;
the authentication form verifies the user's (1) data and processes the access request;
the application route (2) sorts the access request (3) to the web platform's authentication form;
the authorization form, through the RM, identifies the user (1) and rejects the access request (4);
the user (1) reattempts access or forwards the request for access credentials to the blockchain administrators.

5. Method according to claim 1, which comprises the following steps:
the user's (1) access to the web platform;
the user (1) is registered and logs in by providing his or her personal data;
the application route (2) sorts the access request (3) to the web platform's authentication form;
the authentication form verifies the user's (1) data and processes the access request;
the application route (2) sorts the access request (3) to the online platform's authentication form;
the authorization form, through the RM, identifies the user (1) and accepts the access request (3);
the web platform initializes communication with the blockchain, which generates a permanent and unalterable block;
the user (1) selects (6) the first module, which manages remote work;
the web platform's core determines the requested information (7) and defines whether it is present in the web platform;
the web platform's core identifies (8) the requested form and processes the request;
AI interaction with the generated block;
AI's continuous learning to recognize the user (1) and optimize his or her experience on the web platform;
use of the data processed by AI, by the other platform modules, the core, and the blockchain administrators;
the core registers the event;
user's (1) logout;
closing and archiving of the generated block.

6. Method according to claim 1, which comprises the following steps:
the user's (1) access to the web platform;
the user (1) is registered and logs in by providing his or her personal data;
the application route (2) sorts the access request (3) to the web platform's authentication form;
the authentication form verifies the user's (1) data and processes the access request;
the application route (2) sorts the access request (3) to the web platform's authentication form;
the authorization form, through the RM, identifies the user (1) and accepts the access request (3);
the web platform initializes communication with the blockchain, which generates a permanent and unalterable block;
the user (1) selects (6) the second module, which manages welfare services;
the web platform's core determines the requested information (7) and defines whether it is present in the web platform;
the web platform's core identifies (8) the requested form and processes the request;
AI interaction with the generated block;
AI's continuous learning to recognize the user (1) and optimize his or her experience on the web platform;
use of the data processed by AI, by the other platform modules, the core, and the blockchain administrators;
the core registers the event;
user's (1) logout;
closing and archiving of the generated block.

7. Method according to claim 1, which comprises the following steps:
the user's (1) access to the web platform;
the user (1) is registered and logs in by providing his or her personal data;
the application route (2) sorts the access request (3) to the web platform's authentication form;
the authentication form verifies the user's (1) data and processes the access request;
the application route (2) sorts the access request (3) to the web platform's authentication form;
the authorization form, through the RM, identifies the user (1) and accepts the access request (3);
the web platform initializes communication with the blockchain, which generates a permanent and unalterable block;
the user (1) selects (6) the third module, which manages distance training (FAD);
the web platform's core determines the requested information (7) and defines whether it is present in the web platform;
the web platform's core identifies (8) the requested form and processes the request;
AI interaction with the generated block;
AI's continuous learning to recognize the user (1) and optimize his or her experience on the web platform;
use of the data processed by AI, by the other platform modules, the core, and the blockchain administrators;
the core registers the event;
user's (1) logout;
closing and archiving of the generated block.

8. Method according to claim 1, in which access request is activated with the user's (1) Digital Signature and Public Key.

9. Method according to claim 1, in which all the data collected in the web platform are archived by BIL and remain available to the administrators.

10. Method according to claim 5, in which AI monitors the actual operation of the user (1), and extracts KPI based on workloads, processing times, and levels of competence achieved; depending on levels of success, AI suggests services present in the second and third modules.

11. Method according to claim 6, in which the second module that manages welfare services comprises both packages inside the company or employer of the user (1), and extra-core packages provided following contracts between the company or body with outside companies; said contracts are archived in the blockchain, of which the blockchain itself becomes guarantor.

12. Method according to claim 11, in which AI automatically unblocks only the welfare services that the user (1) has earned, for example by having achieved KPls, having accrued a certain amount of remote working hours, having contributed to the company's success, etc, based on the information archived and validated by BIL.

13. Method according to claim 7, in which the FAD service comprises both training courses inside the company or the employer of the user (1), and extra-core training courses provided following contracts between the company or body with outside companies; said contracts are archived in the blockchain, of which the blockchain itself becomes guarantor.

14. Method according to claim 13, in which AI automatically unblocks only the welfare services that the user (1) has earned, for example by having achieved KPls, having accrued a certain amount of remote working hours, having contributed to the company's success, etc, based on the information archived and validated by BIL.

15. Method according to claims 5, 6, and 7, in which the user (1) accesses the web platform with a Smart Key; this method with Smart Key access comprises the following steps:
the Smart Key is associated with the user's (1) personal details before initial use;
the user (1) connects the Smart Key to the computer;
the user (1) accesses the web platform using the Smart Key's credentials;
the user (1) validates his or her own digital identity;
the application route (2) sorts the access request (3) to the web platform's authentication form;
the authentication form verifies the user's (1) data and processes the access request;
the application route (2) sorts the access request (3) to the web platform's authentication form;
the authorization form, through the RM, identifies the user (1) and accepts the access request (3);
the web platform initializes communication with the blockchain, which generates a permanent and unalterable block;
the user (1) selects (6) one from the first, second, and third forms;
the core determines the requested information (7) and defines whether it is present in the web platform;
the core identifies (8) the requested form and processes the request;
AI's continuous learning to recognize the user (1) and optimize his or her experience on the web platform;
use of the data processed by AI, by the other platform modules, the core, and the blockchain administrators;
the core registers the event;
monitoring of the user's operation on the computer, and real-time processing and archiving of the data in the web platform and on the Smart Key;
user's (1) logout;
closing and archiving of the generated block.
the user (1) disconnects the Smart Key from the computer.

16. Method according to claim 15, in which the user (1) accesses the web platform with a Smart Key and performs an operative action with documents, without the need to access the platform via web and to search for the document area and perform the requested action; this action is automatically integrated with the web platform and validated by the blockchain.
